(19) United States
(12) Patent Application Publication
(10) Pub. No.: US 2005/0142665 A1
(43) Pub. Date: Jun. 30, 2005

(54) Laser diffraction method for particle size distribution measurements in pharmaceutical aerosols

(75) Inventors: Herbert Wachtel, Bingen (DE); Jochen Ziegler, Heidelberg (DE)

Correspondence Address: MICHAEL P. MORRIS;BOEHRINGER INGELHEIM CORPORATION, 900 RIDGEBURY ROAD, P. O. BOX 368, RIDGEFIELD, CT, 06877-0368, US

(73) Assignee: Boehringer Ingelheim International GmbH, Ingelheim (DE)

(21) Appl. No.: 11/003,167

(22) Filed: Dec. 3, 2004

(30) Foreign Application Priority Data
Dec. 23, 2003 (EP) 03029721

(51) Int. Cl. G01N 1/22; G01N 1/00

(52) U.S. Cl. 436/181

(57) ABSTRACT

Disclosed are methods for measuring the particle size distribution of a pharmaceutical aerosol by the use of laser diffraction.

### APPLICATION DATA

This application claims benefit to EP 03029721.2 filed Dec. 23, 2003.

### BACKGROUND

In the pharmaceutical industry the determination of particle size distributions (PSD) of nebulized aerosols is important for estimating the deposition characteristic in the lungs. In practice the common principle for measuring the PSD is the impaction method. A cross section of an Andersen cascade impactor (ACI) is shown in FIG. 1. The cascade impactor can be considered as a simplified model of the respiratory system of human beings. The aerosol is guided by means of an air stream at defined flow rate through the rectangular bend (mode! of the human throat) and the following impaction stages (modelling different parts of the bronchial tubes). The impaction stages consist of nozzle plates and impaction plates. The diameter of the nozzles in the nozzle plates adjusts the air stream velocity. When the aerosol stream curves to flow around the obstructing impaction surface those particles will impact that have too much inertia to follow the air stream. If the velocity of the air stream is subsequently increased by passing it through a smaller jet (decreasing the nozzle diameters), which is followed by another impaction plate, some of the particles that succeeded in passing the previous impaction stages may be unable to follow the faster moving air stream and will impact. The stepwise decrease of the jet diameters of the successive impaction stages simulates the air ducts in the lung becoming smaller at each branching.

This method is well accepted by the national medical agencies due to its simplicity and robustness. The whole System 5 defined and can be described by only a few parameters like the flow rate of the air stream, the number of nozzles, the jet diameter defined by the nozzle diameters of the nozzle plates, the distance of the nozzles to the impaction plates and the length of the nozzles. However the process of aerosol analysis is time consuming and therefore not suitable for routine measurements with large batch numbers. Especially the analysis of the different mass fractions on the impaction stages is very labour intensive. Hence it is necessary to establish faster alternatives for particle size determinations. According to the present invention a laser diffraction (LD) method is proposed. In FIG. 2 the set-up of a typical laser diffraction instrument is shown.

According to the method if this invention a laser is used to generate a monochromatic, coherent, parallel beam that illuminates the dispersed particles after expansion by the beam processing unit. The measuring zone should be in the working distance of the lens used. The interaction of the incident light beam with intensity (I) and the ensemble of dispersed particles results in a scattering pattern with different light intensities at various angles. The total angular intensity distribution (I(θ), consisting of both direct and scattered light, is then focused by a lens system onto a multi-element detector. In this way, the continuous angular intensity distribution (I(θ)) is converted into a discrete spatial intensity distribution (I(r)) on a set of detector elements. By means of a computer the particle size distribution can be calculated which best approximates (I(r)).

In order to introduce and establish the laser diffraction method according to the invention as a tool that may replace the cascade impactor for routine measurements on pharmaceutical inhalers, the equivalence of both methods must be proven.

Using continuously operating nebulizers, Clark (Clark, A. R. 1995. The use of laser diffraction for the evaluation of the aerosol clouds generated by medical nebulizers. International Journal of Pharmaceutics 115: 69-78), Kwong et. al. (Kwong, W. T. J., S. L. Ho, A. L. Coates. 2000. Comparison of nebulized particle size distribution with Malvern laser diffraction analyser versus Andersen cascade impactor and low-flow Marple personal cascade impactor. Journal of Aerosol Medicine 13: 303-314) and None et. al. (None, L. V., D. Grimbert, M. H. Bequemin, E. Boissinot, A. le Pape, E. Lemarié P. Diot. 2001. Validation of laser diffraction method as a substitute for cascade impaction in the European project for a nebulizer standard. Journal of Aerosol Medicine 14:107-114) established a good correspondence between the methods regarding the aerodynamic diameters and the geometrical standard deviations. Ziegler and Wachtel (WO 03/012402 A1) described the first successful attempt to establish a correlation between laser diffraction and cascade impaction using aqueous aerosols generated by soft mist inhalers.

For the present invention dedicated equipment is required as the soft mist inhalers generate a high particle density (>10⁶ particles/cm³) for a time span of 1.5 s or less. The measurements were performed simultaneously and evaporation was accounted for by a comparison between volatile liquid and non-volatile aerosols. The aqueous aerosols were generated by a soft mist inhaler which was operated with humidified air with a RH of preferably>90%. The measurements were performed at ambient temperature. For the simultaneous measurement of the PSD with LD and ACI the induction port (also denoted USP-throat) was modified without changing the characteristic impactor geometry.

### SUMMARY OF THE INVENTION

In case of aqueous formulations, reproducible particle size distributions and strict correlation between the ACI and LD method can be obtained at ambient temperature and high humidity (RH>80%, preferably>85%, most preferably>90%). Air conditioning is essential to avoid evaporation not only for ACI but also for LD. The LD results are quite stable against flow rate variations. The induction port should be used also for LD since it gives improved robustness of the method, closer conformance to existing ACI-methods, and facilitates method validation by coupling ACI and LD. The LD is a convenient substitute for the ACI if routine measurements are considered.

The invention as well as the state of the art will be explained by referring to the following figures:

### BRIEF DESCRIPTION OF THE FIGURES

FIG. 1: Schematic of an Andersen cascade impactor. Below the USP throat, the different impaction stages consist of nozzle plates and impaction plates. The nozzle Set) diameters decrease from top to bottom and the impaction plates act as obstacles and collectors for the aerosol.

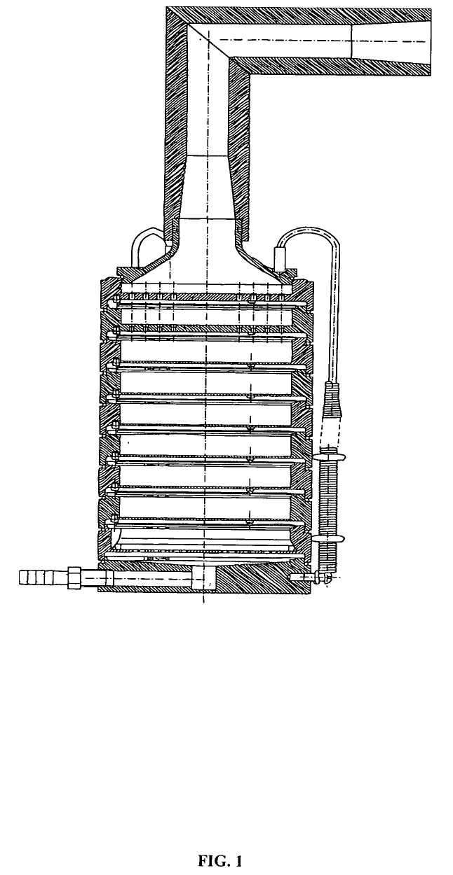

FIG. 2: Example of the set-up of a laser diffraction instrument. The aerosol particles inside the illuminated region contribute to the diffraction pattern.

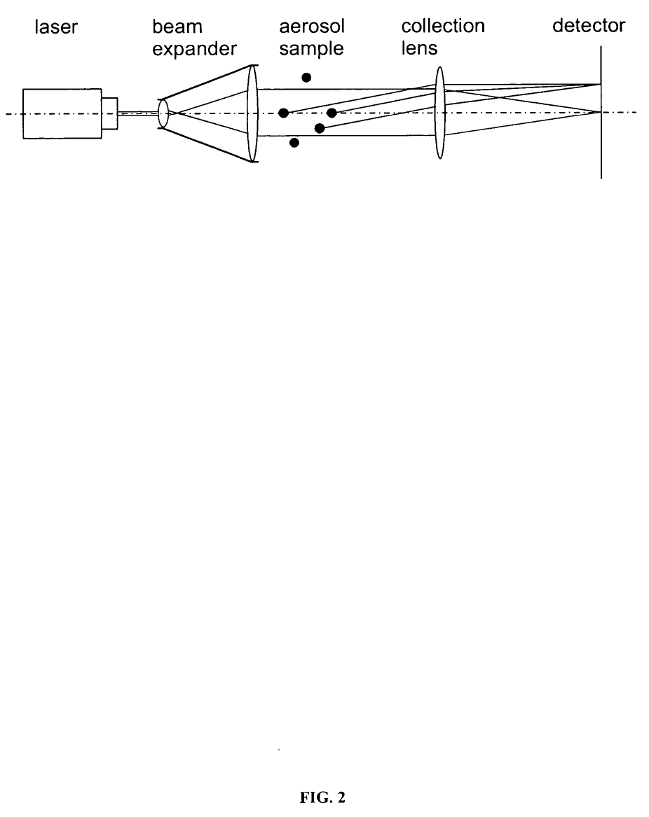

FIG. 3: Front side view of the experimental set-up for simultaneous particle size distribution measurements with the cascade impactor and the laser diffraction method. The distance from the centre of the measurement cone to the lens is 4 cm. The cascade impactor is used in a turned position for technical reasons.

FIG. 4: Visualisation of the modified USP throat. a) windows before the bend b) windows behind the bend. The inlet orifice for the laser beam is not visible.

FIG. 5: Cumulative undersize fraction in dependence of the cut-off diameters. The full lines are sigmoidal fits. Formulation C (c=0.833%) was used.

FIG. 6: The RH of the air influences the laser diffraction results. The detected FPF(<5.8 μm) value increases and the D₅₀ decreases with decreasing humidity. Formulation C (c=0.833%) was used.

FIG. 7: Cumulative Fraction (CF) versus particle diameter measured by LD. The flow rate was varied between 18 l/min and 38 l/min. The black area covers all CF curves for all flow rates. Formulation C (c=0.833%) under saturated air conditions.

FIG. 8: Comparison of the Cumulative Fraction (CF) for different measurement conditions (ACI versus LD and RH>90% versus RH˜30-45%). The distributions were not measured simultaneously. Formulation C (c=0.833%) was used.

FIG. 9: Cumulative Fraction (CF) versus the cut-off diameters of the ACI for the formulation A (c=0.049%).

FIG. 10: Cumulative Fraction (CF) versus the cut-off diameters of the ACI for the formulation B (c=0.198%).

FIG. 11: Cumulative Fraction (CF) versus the cut-off diameters of the ACI for the formulation C (c=0.833%).

FIG. 12: Water droplet lifetimes as function of droplet size for 0, 50 and 100% relative humidity at 20° C. (after Hinds (1982)).

FIG. 13: Cumulative Fraction (CF) measured with the ACI in dependence of the Cumulative Fraction (CF) measured with LD. The experimental data represent the respective cut-off points of the ACI (i.e. the CF values for the 0.4, 0.7, 1.1, 2.1, 3.3, 4.7, 5.8, 9.0 and 10.0 micrometer cut-off sizes). Each formulation is dose to the ideal case (straight line) where CF_{ACI} and CF_{LD} should be equal.

### DESCRIPTION OF THE INVENTION

The present invention shows that the Andersen Cascade Impactor (ACT) and the Laser Diffraction method (LD) can be correlated for aqueous drug formulations at ambient temperature. Therefore a comparison of the two particle size determination methods at different conditions (flow rate, relative humidity) was performed. Under well defined conditions, the Particle Size Distribution (PSD) is independent of the method of investigation, and the faster LD, which is subject of the present invention, can substitute the time consuming ACI at least for routine measurements.

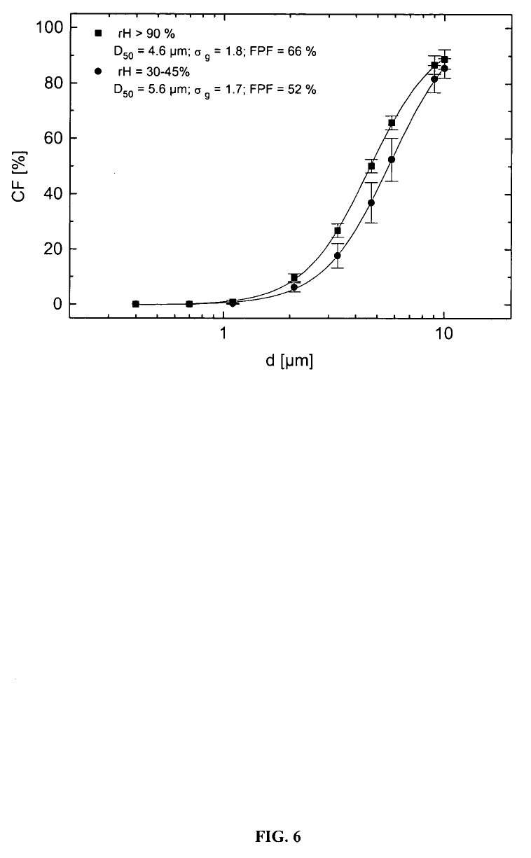

The measurements were performed with three different drug formulations. The aerosol was generated by soft mist inhalers, such as the Respimat®-device as disclosed in WO97/12687, in particular the device of FIGS. 6a and 6b, and the droplet distributions were measured simultaneously using a laser diffraction analyser together with the 8-stage Andersen cascade impactor. In order to measure the scattered laser light intensity of the aerosol passing the induction port, according to the invention glass windows were fitted to the induction port. The evaporation effect of the aqueous aerosols on the PSD was investigated at ambient humidity and high humidity (RH>90%). The simultaneous determination of the droplet size distribution leads to a good correlation between the ACI and LD method, in particular if the measurements were performed at RH>90%. The humidity of the ambient air shows interesting influence on PSD. Best results were achieved if the air was almost saturated with humidity. The influence of the flow rate on LD was negligible, whereas for ACI, the expected flow rate dependence holds. The advantages of LD and the demonstrated compatibility to established EPIUSP methods motivate the substitution of the ACI and the use of LD for routine measurements.

In the following description the following abbreviation will be used: alpha: level of significance (alpha=0.05 in this report)

ACI: Andersen cascade impactor

c: concentration of the drug formulation

CF: cumulative undersize fraction

D₁₆: diameter at 16% cumulative fraction

D₅₀: diameter at 50% cumulative fraction

D₈₄: diameter at 84% cumulative fraction

FPF(<5.8 μm): Fine particle i.e. fraction of particles with diameters less than 5.8 micrometer

I (θ): Intensity of diffracted light as function of angle

θ (Greek theta)

I (r) spatial intensity distribution

lambda: laser wavelength

LD: Laser diffraction

micron: micrometer

PSD: Particle size distribution

RH: relative humidity

SD: Standard deviation

Sigma g (as well as written as Greek letter): geometric standard deviation

T: Boiler temperature of the Sinclair LaMer aerosol generator

For the study Respimat® soft mist inhalers were used to generate the aqueous aerosols. The investigated formulations contained different active drugs (active drug concentration c indicated) as well as excipients. They are called formulation A (c=0.049%), B (c=0.198%), and C (c=0.833%). By this choice, the concentration c of drugs ranged from c=0.049%, 0.198% to 0.833% . A single actuation of the inhaler resulted in a spray duration of 1.5 seconds.

The non-volatile aerosol was generated with a Sinclair-LaMer type aerosol generator MAG-2010 (PALAS® GmbH in D-76229 Karlsruhe, Germany). This aerosol was used for testing the reliability of the laser diffraction analyser. The generator is capable to generate adjustable particle diameters between approximately 0.3 micrometer and 6 micrometer with a geometric standard deviation sigma g less than 1.15 and a number concentration up to 10⁶ cm⁻³. In the boiler where the aerosol material is vaporised the temperature controls the particle diameter. The corresponding aerosol material is DEHS (Di-2-Ethylhexyl-Sebacate).

Aerosol droplet distributions were measured using the Sympatec HELOS laser diffraction analyser (Sympatec GmbH, D-38678 Clausthal-Zellerfeld, Germany) at lambda=632.8 nm (He—Ne laser) together with an Andersen Mark II 8-stage cascade impactor operated at 28.3 L/min with the corresponding cut-off points 0.4, 0.7, 1.1, 2.1, 3.3, 4.7, 5.8 and 9.0 micrometer. As an experimental restriction, particles with diameters below I micrometer are hardly detectable with the LD configuration used for the presented measurements.

The analysis of the drug was performed in the case of formulation C with an UV/VIS scanning spectrophotometer at the wavelength lambda=218 nm and sometimes additionally at the wavelength lambda=276 nm. The detection of the other two formulations A and B was performed with standardised HPLC because of their lower drug concentrations.

For the control of the reliability of the generated data the laser diffraction apparatus was tested with a reference reticle. The reference reticle consists of silicon particles of defined sizes deposited onto a glass slide. The size distribution of the reticle was measured with the laser diffraction apparatus used for the measurements and with a laser diffraction apparatus of the same type as a reference. The results were compared with the nominal values given for the reference reticle. The laser diffraction analyser was additionally tested with a monodisperse aerosol. The generation process of the test aerosol is based on the Sinclair-LaMer principle by condensation of the vaporised aerosol material at nuclei. The _{”}heart“ of the generator is the condensation nuclei source. The nuclei source was a pure sodium chloride solution, the aerosol material was DEHS (Di-2-Ethylhexyl-Sebacate). Three different monodisperse particle size distributions with D₅₀ values between 2 micrometer and 6 micrometer were generated and measured simultaneously with the laser diffraction analyser and the cascade impactor.

Evaporation Effects

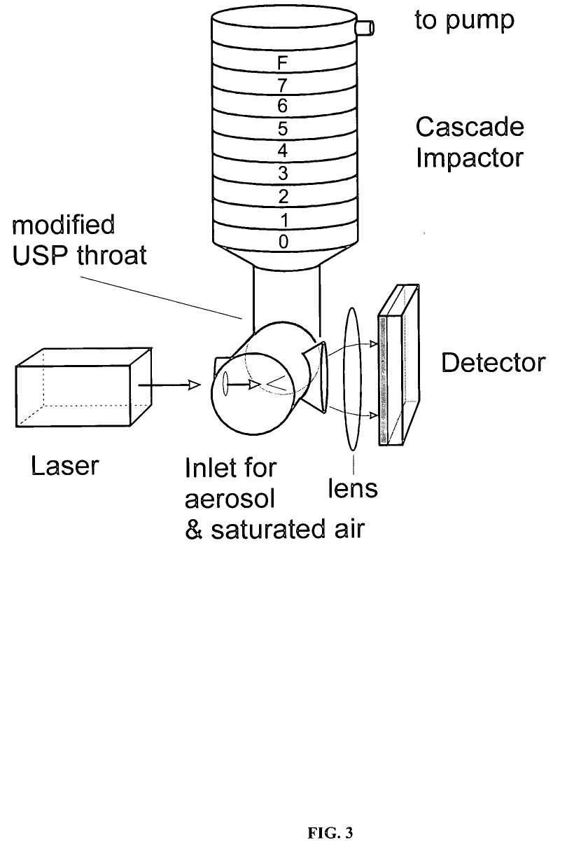

In addition to measurements under ambient humidity (relative humidity RH about 30%-45%) the particle size distribution was investigated under water vapour saturated air (RH >90%) conditions to study the evaporation effect of the aqueous aerosols. The schematic experimental set-up is shown in FIG. 3.

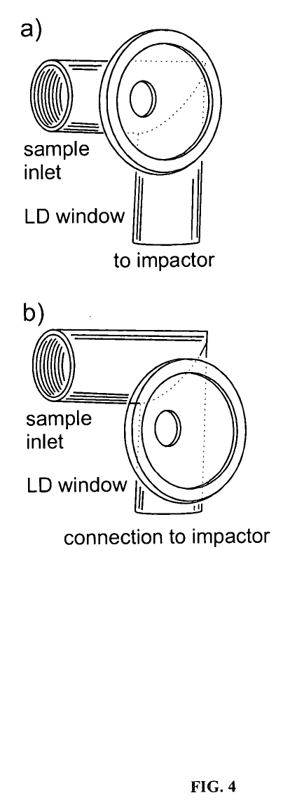

In order to measure the scattered laser light intensity of the aerosol passing the induction port, two holes were drilled in front of the bend of the port which were sealed with O-rings and glass windows. A three dimensional side view of the modified USP throat is presented in FIG. 4a.

Some experiments were also performed with an induction port having the holes and glass windows behind the bend (FIG. 4b). This bend represents a first impaction stage for large particles and therefore these particles can be detected neither by the laser diffraction nor by the cascade impactor. From the point of view of quality control, the windows positioned before the bend are preferred, because in this position all droplets can be detected by the laser system.

Irrespectively of the window position it is possible with this set-up to measure the PSD with the cascade impactor and the laser diffraction method simultaneously. To ensure sufficient drug deposition on all the impactor plates to allow for UV spectrophotometric or HPLC analysis, 4 to 8 actuations per measurement were collected. For the laser diffraction data analysis the Mie-theory is used which is applicable for transparent spheres (Kerker, M. 1969. The scattering of light and other electromagnetic radiation. Academic Press, New York). For that purpose the refraction and absorption index of the droplets must be known. The refraction index of the aqueous aerosol particles was 1.33 and the absorption was 0.0. For the DEHS particles, the refraction index was 1.45 and the absorption was 0.0. The advantage of the Mie correction is that it takes into account the increased scattering of light from smaller droplets compared to the Fraunhofer theory (Merkus, H. G., J. C. M. Marijnissen, E. H. L. Jansma, B. Scarlett. 1994. Droplet size distribution measurements for medical nebulizers by the forward light scattering technique. Journal of Aerosol Science 25 Suppl. 1: S319-S320 and Corcoran, T. E., R. Hitron, W. Humphrey, N. Chigier.2000. Optical measurement of nebulizer sprays: A quantitative comparison of diffraction phase doppler interferometry, and time of flight techniques. Journal of Aerosol Science 31: 35-50).

The PSD measured with laser diffraction was calculated automatically from the scattered light intensities striking the 31 detector elements. The Sympatec HELOS software used for the calculation was WINDOX version 3.3.

The basis for the calculation of the PSD measured with the cascade impactor was the total mass detected with the photometer or HPLC i.e. the total mass is the sum of all masses recovered on the different impaction stages and in the USP throat.

All PSD data were converted in percentage of the cumulative undersize fraction CF with relation to the cut-off diameters of the cascade impactor e.g. CF(5.8 micrometer) means the fraction in percentage of a particle ensemble with diameters less or equal than 5.8 micrometer.

The PSD and the characteristic aerosol parameters D₅₀ sigma g and Fine Particle Fraction (<5.8 μm) (FPF) measured with the two particle size detection methods were evaluated qualitatively (visual assessment) and quantitatively by means of a significance analysis (F test, t-test, confidence intervals) (Sachs, L. 2002. Angewandte Statistik; Springer Verlag; 2002, p.178-216). The geometric standard deviation sigma g is given by:

$${σ}_{g} = {[ \frac{{\sum }^{} {{n}_{i} ( ln {d}_{i} - ln {d}_{g} )}^{2}}{N - 1} ]}^{\frac{1}{2} } {d}_{g} = {( {d}_{1} Λ {d}_{N} )}^{\frac{1}{N}} \qquad Equ . 1$$

nᵢ: number of particles with diameter dᵢ

N: total number of particles

d_{g}: geometric particle diameter

Under the prerequisite of a log-normal distribution (the logarithm of the particle diameters is normal distributed) the geometric standard deviation is equal to:

$${σ}_{g} = \frac{{D}_{84}}{{D}_{50}} = \frac{{D}_{50}}{{D}_{16}} = {[ \frac{{D}_{84}}{{D}_{16}} ]}^{\frac{1}{2}} \qquad Equ . 2$$

Equ. 2 is used in the following for calculating sigma g. D₅₀ is the median diameter, D₁₆ and D₈₄ are the diameters at which the cumulative size distribution reaches 16% and 84% respectively.

The results of the reticle measurements are shown in Table 1. In order to obtain representative results, seven measurements per laser diffraction analyser at different reticle positions were performed. The results of the test analyser, which was used for all subsequent investigations, show excellent correspondence to the reference analyser results. All nominal values are slightly but significantly (level of significance alpha=0.05) higher than the measured ones.

TABLE 1
PSD of a reticle measured with two laser diffraction analysers of
the same type (test analyser and reference analyser). The mean
values of D₁₀, D₅₀ and D₉₀ are compared with the nominal value.

| | Test analyser | Reference analyser | |
|---|---|---|---|
| | (n = 7) | (n = 7) | Nominal value |
| D₁₀ [μm] ± SD | 27.49 ± 0.84 | 27.61 ± 0.47 | 30.61 |
| D₅₀ [μm] ± SD | 36.85 ± 1.58 | 36.91 ± 1.16 | 39.05 |
| D₉₀ [μm] ± SD | 47.03 ± 2.12 | 47.54 ± 2.48 | 49.69 |

Since the reticle spot diameters are quite large it is reasonable to control the reliability of the laser analyser in a size range less than 10 micrometer. No reticle was available in this size interval. Therefore an aerosol generator was used. The characteristic parameters of the monodisperse PSD generated by the MAG-2010 aerosol generator are presented in Table 2. Three different boiler temperatures and hence three PSD were investigated simultaneously with the laser diffraction apparatus and the cascade impactor. The cascade impactor served as the reference test method.

TABLE 2
PSD of a monodisperse test aerosol of DEHS. The particle size was
tuned by the temperature T. For each temperature at least eight
measurements were performed.

| | | Laser | Cascade |
|---|---|---|---|
| | | Diffraction | Impaction |
| | | (n ≧ 8) | (n ≧ 8) |
| T = 180° C. | D₅₀ ± SD [micron] | 1.92 ± 0.10 | 2.29 ± 0.38 |
| | Sigma g ± SD | 1.17 ± 0.32 | 1.32 ± 0.32 |
| T = 210° C. | D₅₀ ± SD [micron] | 3.33 ± 0.18 | 3.90 ± 0.06 |
| | Sigma g ± SD | 1.16 ± 0.08 | 1.12 ± 0.03 |
| T = 240° C. | D₅₀ ± SD [micron] | 6.03 ± 0.30 | 5.60 ± 0.17 |
| | Sigma g ± SD | 1.19 ± 0.07 | 1.15 ± 0.25 |

The D₅₀ values for the 210° C. and 240° C. boiler temperature show differences from 0.41 μm to 0.6 μm between the two detection methods. The D₅₀ value for the 180° C. boiler temperature and all geometric standard deviations are statistically equal.

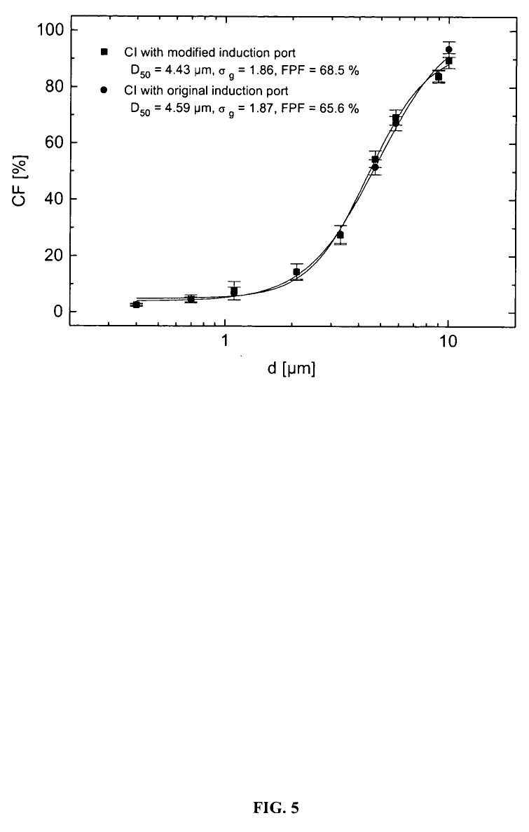

The original induction port was modified and the usual position of the impactor was changed during the simultaneous measurements with laser diffraction and cascade impactor. These modifications do not distort the PSD, as shown in FIG. 5. The cumulative fraction curves strongly overlap and justify the use of the modified throat for the correlation studies. For the experiment the formulation C with the highest concentration (c=0.833%) was used and all measurements were performed under saturated air conditions (RH>90%).

It is obvious that the humidity of the air strongly affects the PSD of aqueous aerosols measured with the cascade impactor. Due to evaporation the size distribution is shifted to smaller particles if RH is reduced. Even if the laser diffraction method was used, where evaporation should not play such a dominant role as for the cascade impactor because of shorter times of flight, the PSD depends also on the relative humidity of the ambient air. This is presented in FIG. 6. The data relate to laser diffraction measurements on formulation C with the highest drug concentration (c=0.833%). The flow rate was 28.3 L/min.

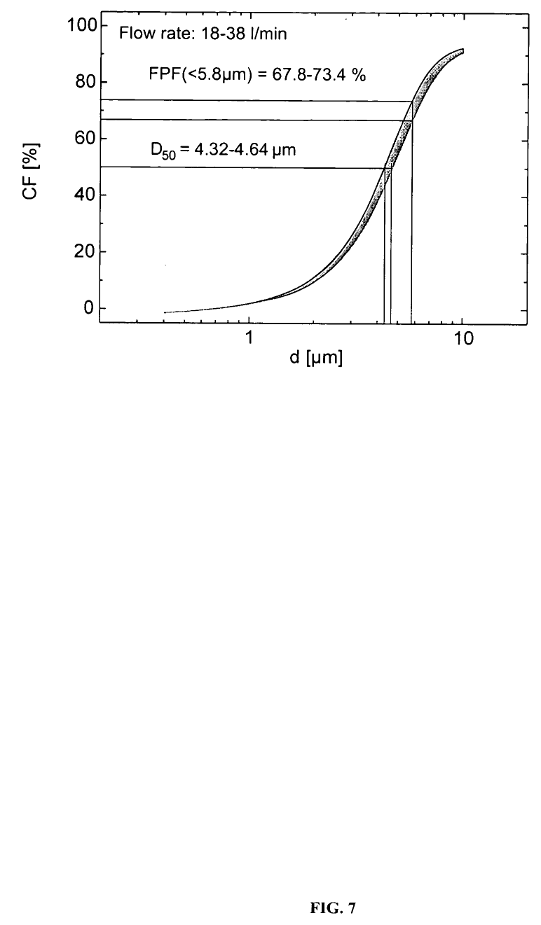

The PSD was investigated by laser diffraction for different flow rates and under saturated air conditions (FIG. 7).

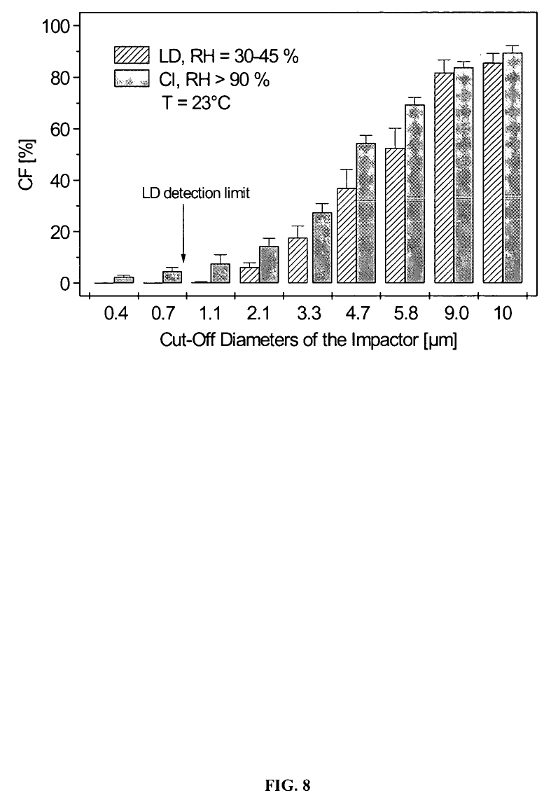

The flow rate was varied between 18 L/min and 38 L/min. The black area in FIG. 8 covers the corresponding cumulative fraction curves. No systematic dependence was established between the flow rate and the D₅₀ values or FPF respectively. The measurements were performed with the formulation C with concentration c=0.833% under saturated air conditions.

In order to investigate the influence of the glass window position at the induction port, two induction ports were used. One port had the windows in front of the bend (FIG. 4a) another port had the windows behind the bend (FIG. 4b). The measurements were performed with the formulation C with concentration c=0.833% under saturated air conditions. The characteristic aerosol parameters are presented in Table 3. The D₅₀ values are statistically equal (alpha=0.05) and the Fine Particle Fraction (FPF(<5.8 μm)) values show overlapping error bands. The geometric standard deviation is larger for the LD method which is however not systematic as one can see from the sigma g value in Table 2 related to the DEHS boiler temperature T=180° C.

TABLE 3
Characteristic aerosol parameters simultaneously measured with
ACI and LD. The induction port windows were positioned behind
the bend of the USP throat. The results are based on six
measurements. Formulation C (c = 0.833%) was used.

| | ACI (n = 6) | LD (n = 6) |
|---|---|---|
| D₅₀ ± SD [micron] | 4.17 ± 0.26 | 4.12 ± 0.15 |
| Sigma g ± SD | 1.61 ± 0.04 | 1.73 ± 0.04 |
| FPF(<5.8 μm) ± SD [%] | 77.2 ± 2.5 | 74.2 ± 1.9 |

The motivation for the present comparison between ACI and LD is best illustrated by FIG. 8. It shows the particle size distributions for formulation C, measured separately with the cascade impactor at RH>90% and the laser diffraction method under ambient conditions. The cumulative fractions differ significantly from each other for diameters less than 9 micrometer. A detection of particles below 1 micrometer was hardly possible with LD.

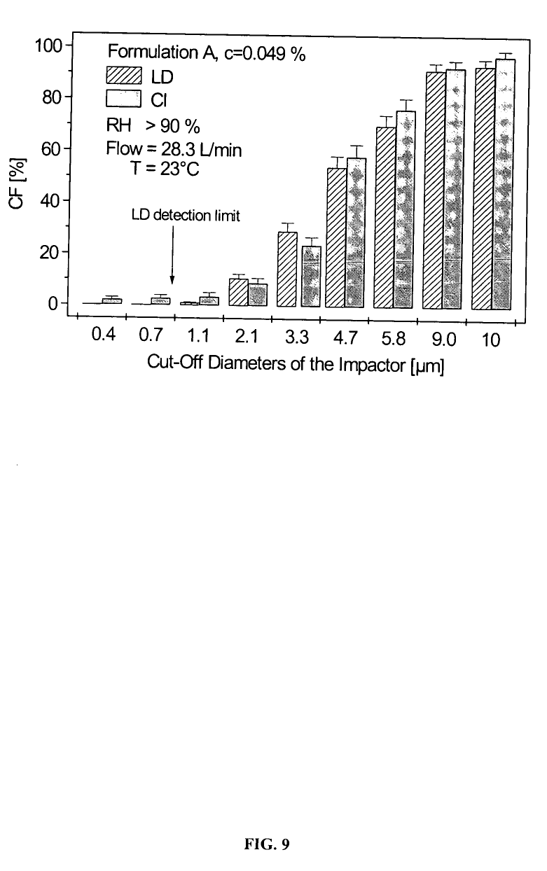

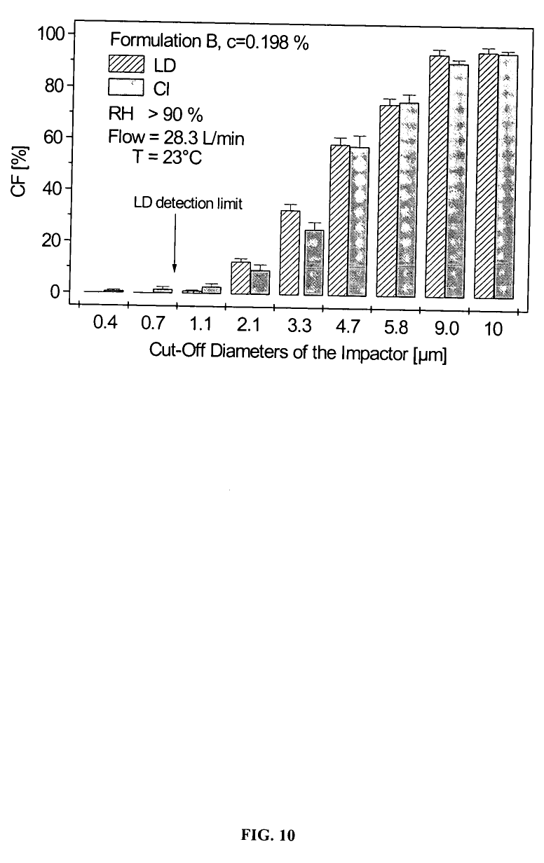

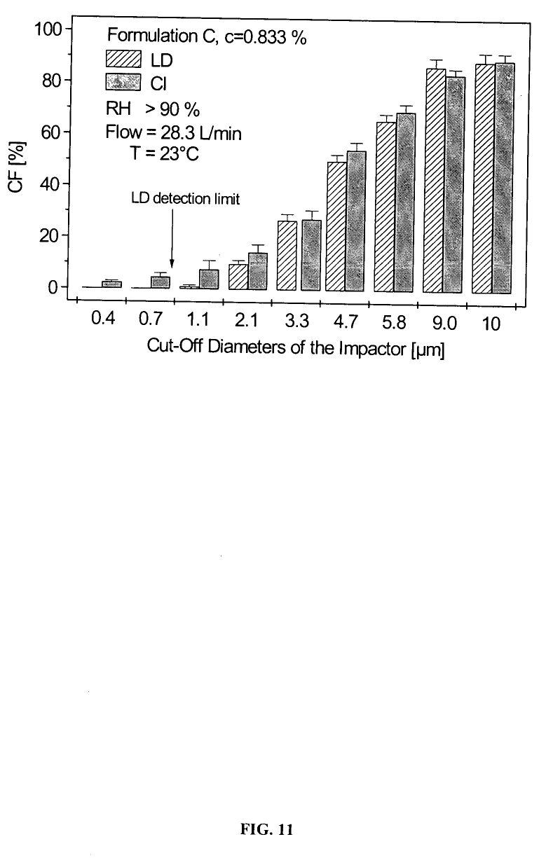

The best way to investigate the correlation of two PSD analysers is the simultaneous measurement of the particle size distribution with both methods. The correlation studies were performed at RH >90% (measurement of RH behind the impactor) and at a flow rate of 28.3 L/min for all drug formulations. The modified induction port having the inlet and outlet windows for the laser beam in front of the bend (FIG. 4a) was used. The experimental set-up is depicted in FIG. 3. In the FIGS. 9 to 11 the histograms illustrate the PSD correlation between the LD and ACI method.

FIGS. 9 to 11 show an excellent correspondence between the LD and the ACI results. This is definitively due to the fact that the PSD was measured simultaneously under defined conditions i.e. constant flow rate and saturated air, in contrast to the measurement presented in FIG. 8. Table 4 summarises the corresponding characteristic aerosol parameters D₅₀, sigma g and FPF(<5.8 μm).

TABLE 4
D₅₀, sigma g and FPF (<5.8 μm) for the different formulations A, B, C.

| | Formulation A | | Formulation B | | Formulation C | |
|---|---|---|---|---|---|---|
| | (c = 0.049%) | | (c = 0.198%) | | (c = 0.833%) | |
| | ACI (n = 17) | LD (n = 17) | ACI (n = 18) | LD (n = 18) | ACI (n = 13) | LD (n = 12) |
| D₅₀ ± SD | 4.37 ± 0.24 | 4.42 ± 0.24 | 4.34 ± 0.18 | 4.16 ± 0.14 | 4.43 ± 0.19 | 4.59 ± 0.17 |
| [micron] | | | | | | |
| Sigma g ± SD | 1.52 ± 0.05 | 1.72 ± 0.05 | 1.57 ± 0.03 | 1.72 ± 0.03 | 1.86 ± 0.14 | 1.76 ± 0.04 |
| FPF ± SD [%] | 76.9 ± 4.0 | 69.7 ± 3.9 | 74.4 ± 2.9 | 73.8 ± 2.5 | 68.5 ± 2.3 | 66.2 ± 2.7 |

In Table 5 the different cut-off points of the ACI are summarised in three size intervals from [0 micrometer; 1.1 micrometer], [1.1 micrometer; 4.7 micrometer] and from [4.7 micrometer; 10 micrometer]. The corresponding cumulated fractions CF are compared for the ACI and LD method. Except for the [0 micrometer; 1.1 micrometer] interval good equivalence between the ACI and LD method can be found. The higher CF values of the ACI evaluation in comparison to the LD for the [0 micrometer; 1.1 micrometer] interval are caused by the detection limit of the LD.

TABLE 5
Cumulative fraction of ACI and LD for different size intervals. Additionally the 1σ
standard deviation is shown.

| | Formulation A | | Formulation B | | Formulation C | |
|---|---|---|---|---|---|---|
| | (c = 0.049%) | | (c = 0.198%) | | (c = 0.833%) | |
| | ACI (n = 17) | LD (n = 17) | ACI (n = 18) | LD (n = 18) | ACI (n = 13) | LD (n = 12) |
| CF_{[0 micron;1.1 micron]} | 3.31 ± 2.71 | 0.94 ± 0.31 | 2.75 ± 1.69 | 1.06 ± 0.23 | 7.63 ± 4.03 | 0.86 ± 0.68 |
| [%] | | | | | | |
| CF_{[1.1 micron;4.7 micron]} | 54.95 ± 7.24 | 53.24 ± 6.69 | 55.25 ± 6.61 | 57.67 ± 4.67 | 46.83 ± 7.79 | 49.27 ± 4.68 |
| [%] | | | | | | |
| CF_{[4.7 micron;10 micron]} | 39.16 ± 8.62 | 39.54 ± 8.85 | 36.69 ± 6.37 | 36.40 ± 5.50 | 35.02 ± 6.29 | 38.69 ± 7.31 |
| [%] | | | | | | |

The laser diffraction analyser worked reliable. No significant difference was established between the analyser and a reference analyser of the same type by measuring the well-defined size distribution of a reticle. The deviations of the results from the nominal values provided by the manufacturer are possibly caused by the static feature of the reticle, which is only under special prerequisites a suitable model for a moving particle system (Mühlenweg, H; E. D. Hirleman. 1999. Reticles as Standards in Laser Diffraction Spectroscopy. Part. Part. Syst. Charact. 16:47-53). The ACI and LD method show satisfactory equivalence in respect to the generated reference particle distributions. The small differences appeared mainly due to the calibration uncertainty of the impaction plates or of the software calibration (see Table 1). The calibrations differ in some respect from the manufacturers' calibration, but are sufficiently consistent with theory. The investigation of the impaction plate calibration is described by Nichols, S. C. 2000. Andersen Cascade Impactor: Calibration and Mensuration Issues for the Standard and Modified Impactor. PharmEuropa; 12(4): 584-588 and Vaughan, N. P. 1989. The Andersen Impactor: Calibration, Wall Losses and Numerical Simulation.

Journal of Aerosol Science 20(1): 67-90. Data reduction methods for the evaluation of cascade impactor results are discussed recently by O'Shaughnessy, P. T., O. G. Raabe. 2003. A Comparison of Cascade Impactor Data Reduction Methods. Journal of Aerosol Science and Technology 37: 187-200. The sharp distribution (sigma g<1.15 according to the specification) of the aerosol PSD generated with the MAG-20 10 PALAS aerosol generator enhances the sensitivity against calibration differences.

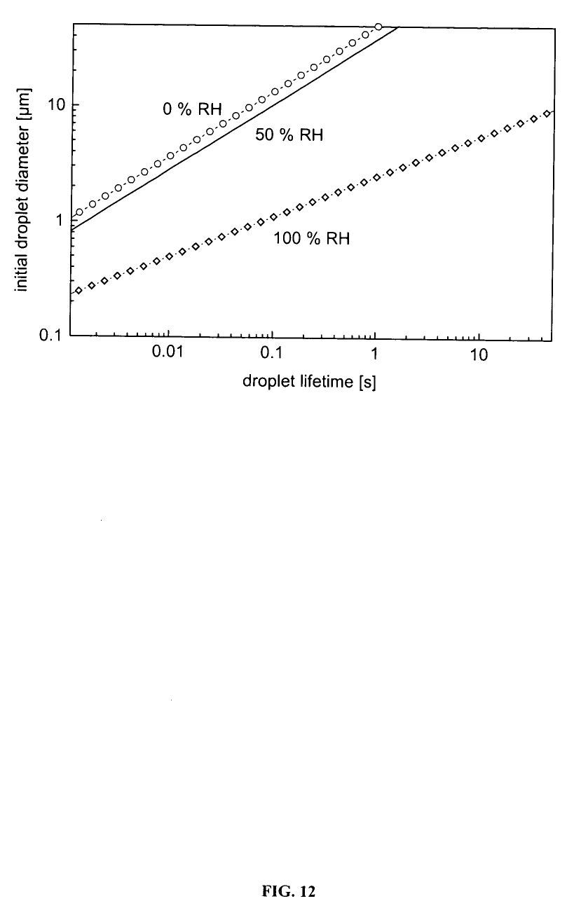

At a first glance one might assume that the evaporation of aqueous aerosol droplets does not influence the PSD if the fast LD method is used. However according to FIG. 12 (after Hinds, W. C. 1982. Aerosol Technology: Properties, Behaviour, and Measurement of Airborne Particles. John Wiley & Sons. 270) the lifetime of aqueous droplets with particle diameters between 1 micrometer and 10 micrometer is in the millisecond range for RH≦50%.

The time of flight of the aqueous droplets from the nozzle to the laser beam is also in the millisecond range as can be calculated from the velocity of the aerosol cloud and the nozzle laser beam distance by a time of flight approximation. Therefore the evaporation of the aqueous droplets cannot be neglected during the laser diffraction measurements. The finite droplet lifetime even for RH=100% (cf. FIG. 12) is caused by the curvature of the droplets. At curved surfaces the vapour pressure is higher than at smooth surfaces due to larger mean distance of the neighbouring particles. The attractive interaction is therefore reduced. Further the particle shrinkage is non-linear i.e. the smaller the initial particles are, the faster is the shrinkage rate. This evaporation behaviour in connection with the detection limit of the configuration of the LD apparatus may explain the situation in FIG. 6. It shows the unexpected situation that for LD at reduced relative humidity the detected FPF(<5.8 μm) became smaller. Concomitantly, the D₅₀ value increased.

This observation at RH about 30-45% can be explained by a fast evaporation of the droplets which reduces the size of the smaller droplets below the detection threshold of the LD device. A comparison of LD and ACI will fail at low relative humidity if the measurement range is not adapted to the dried droplets. On the other hand at RH>90% the particles are relatively stable in size. Thus at almost saturated conditions the measured PSD represents the original one better and leads to D₅₀ and FPF(<5.8 μm) values which are stable in time and which are in good agreement with the impactor values.

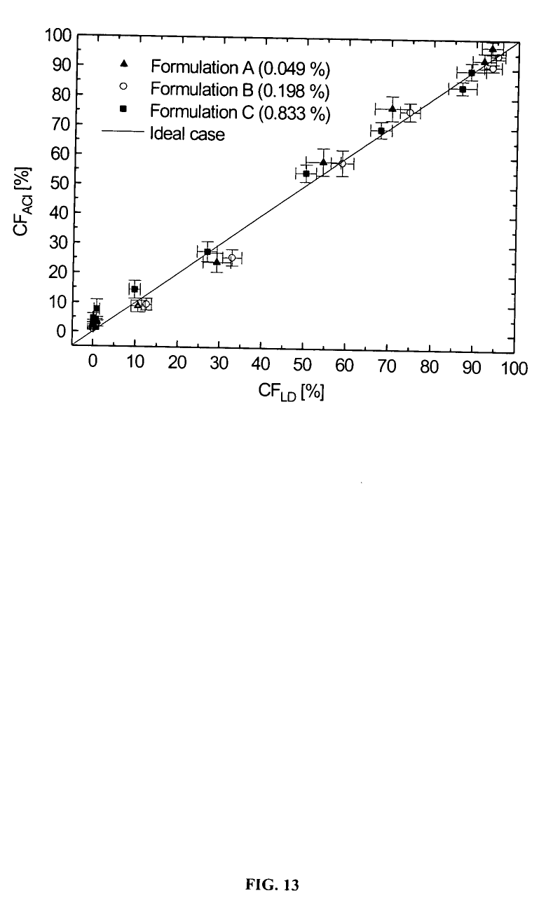

In FIG. 13 a direct comparison between the cumulated fractions measured with LD and ACI is presented for the investigated formulations at RH>90%.

The correlation between the ACI and LD method is satisfactory. Almost all data points are positioned dose to the ideal line. The higher cumulative fraction of the ACI at cut-off sizes below I micrometer is caused by the detection limit of the lens. Other factors that influence the correlation are the beam diameter, possibly scattered light from the surroundings and eventually the evaluation software. The beam diameter is 2.2 mm and therefore only a part of the aerosol cloud was illuminated by the laser beam. This part is quite representative for the PSD of the whole cloud as FIG. 13 proves, but slight deviations cannot be excluded. The choice of another lens connected with a larger beam diameter has the disadvantage to shift the detection limit to larger particle diameters. Also the cascade impactor results do not exactly represent the original PSD of the aerosol. One possible source of error is the already mentioned calibration uncertainty. The amount of aerosol deposited onto the walls of the impactor (wall losses) is usually only 2-3% for the Respimat® device and was therefore neglected in the data evaluation. However according to the investigations by Vaughan (see above) wall losses can become serious under special measurement conditions.

1. A method for measuring the particle size distribution of a pharmaceutical aerosol by the use of laser diffraction, comprising:
in a first step generating an aerosol by means of an inhaler and spraying into pre conditioned air with a relative humidity of at least 80%;
in a next step analyzing by means of laser diffraction the aerosol particle size distribution being embedded into the pre-conditioned air.

2. The method according to claim 1 wherein the pharmaceutical aerosol is an aerosol of liquid droplets.

3. The method according to claim 2, wherein the relative humidity is at least 85%.

4. The method according to claim 2, wherein the relative humidity is at least 90%.
